(19) United States
(12) Patent Application Publication
(10) Pub. No.: US 2014/0238891 A1
(43) Pub. Date: Aug. 28, 2014

(54) Mobile pet storage case

(71) Applicants: Melissa Tagliamonte, Salem, NH (US); Stephen J. Gaudet, Nashua, NH (US)

(72) Inventors: Melissa Tagliamonte, Salem, NH (US); Stephen J. Gaudet, Nashua, NH (US)

(21) Appl. No.: 13/815,407

(22) Filed: Feb. 28, 2013

(51) Int. Cl. A01K 29/00

(52) U.S. Cl. CPC A01K 29/00
USPC 206/581

(57) ABSTRACT

A mobile pet storage compartment case is disclosed herein. The compartment case comprises an interior chamber that can be used to store pet items such food, toys, clothing and the like. The present invention further discloses external platforms that can be used in conjunction with the case. Such platforms include nutritional platforms that can be used for food and water. Other external platforms include devices that can be used by an animal for ease of movement from the ground to the top of the case, wherein the top can serve as a surface for a pet bed.

### BACKGROUND OF THE INVENTION

### Field of the Invention

The present invention relates to a compartment case. In particular, this compartment case can be used to store away items for pets as well as a platform for pets to rest upon. Further, this case can be used as a food and water platform. Still further, this compartment case may be movable such that one may use it for travel or simply move it from one room to another.

### SUMMARY OF THE INVENTION

The present invention is directed to a compartment case (or simply “case”) that can be used to secure pet items such as toys, food, clothing and the like. Further, this case can further be used as a pet bed. Still further this case can be used as a platform for pet food and water. This case comprises at least one container having at least one interior chamber accommodating said pet items. The container is comprised of at least one side. In one aspect the container has multiple sides. Embodiments of the present invention comprise the container having one, two, three, four, or more sides. The case additionally has at least one external platform that can be used by the pet to access a surface of the container which may be used as a bed-like surface. The case additionally comprises one or more external platforms for dispensing or accessing food and or water. Additionally, the case comprises one or more portals allowing access to the interior chamber of the case. One or more of said portals are disposed along one or more of the sides of the container. Optionally, one or more of the portals can have a barrier associated with it that can be selectively opened allowing access to the interior of the case.

In one aspect of the present invention, one of the sides of the case can be optionally opened thus allowing access to the interior chamber of the case. In a particular aspect, the side is the top side (or simply “top”). This surface may optionally have one or more hinge elements associated with it in order to facilitate the opening of said side. Further, in an additional aspect, this side can be secured to the case by means known in the art such as a latch.

In another aspect of the present invention, the case has one or more portals allowing access to the interior of the container wherein said portals are disposed along one or more of the sides of said container. These portals can be openings disposed along the side of said container. Alternatively, these portals can comprise access barriers such as one or more doors thus allowing one to open and close access to the interior of the container from the exterior. In one aspect, these doors comprise a hinge element thus allowing for selectively opening and closing of said door. Herein the term “door” means any movable or displaceable barrier that is disposed within the portals and facilitate access from the exterior of the case to its interior.

In another aspect of the present invention, the case comprises one or more chambers within the interior of the container. These chambers may be permanent or moveable. They can be moveable in that a partitioning element(s) can be moved thus forming a new compartment design.

In another aspect of the present invention, the case comprises one or more drawers. These drawers may be used to secure items within the interior of the container. These drawers permit access from the exterior of the case.

In another aspect of the invention, the interior chamber of the case may further comprise additional defined sub-chambers, defined by one or more partitioning elements.

In another aspect of the present invention, one or more of the surfaces of the container comprise slots into which exterior platforms may be removably affixed. These slots may include varying dimensions thus permitting various external platforms to be secured to a side of the container. In one aspect, an external platform comprises one or more receptacles for a bowl. The bowl or bowls can be used for food and/or water. This external platform comprises a male part to complimentarily match a female slot disposed along a side of the container. In one aspect, an external platform comprises a staircase for which a pet may access a side, for example the top side, wherein said top side may be used as a bed. Optionally, this top side may comprise one or more cushions to aid in comfort for the animal. This external platform may be removably affixed to a side of the container by a manner well known to those skilled in the art. Such a manner may include without being limiting by marrying a female and male element, wherein said female element may be represented by a slot disposed along a side of the case and the male element as being part of the external platform. In another aspect, the external platform can be a planar surface in which the animal accesses a bed-containing side by walking atop the planar surface platform, it serving essentially as a ramp. Optionally, this platform can comprise a rough or textured surface in order to improve friction between the animal's feet (paws) and platform.

In another aspect of the present invention, a receptacle for an animal's leash can be affixed to one or more of the sides of the case. This receptacle permits one to attach an animal's leash to the case.

In yet another aspect of the present invention, one or more handles are affixed to one or more of the sides of the container. This option, for example, promotes ease of movement.

In still another aspect of the present invention, the case is movable. In a particular aspect, wheels or the like are removably affixed to one side of the case such as the bottom side (or simply “bottom”) 7. Optionally, affixed to one or more sides of the container can be anti-skid pads or devices. Such anti-skid pads or device can be permanently affixed or be removable.

Additional features of the present invention will become evident from the description of the drawings as well as from the detailed description of the invention.

### BRIEF DESCRIPTION OF THE DRAWINGS

FIG. 1 is a perspective of an embodiment of the present invention showing the internal compartment of the case.

FIG. 2 is a perspective of the present invention showing the case when the case is closed off to the external environment as well as one of the portals being shown.

FIG. 3 is a perspective view showing the case having one or more slots on one of its sides and two external platforms.

### DETAILED DESCRIPTION OF THE INVENTION

Disclosed herein are detailed embodiments of the present invention. However, it should be understood that the disclosed embodiments are merely exemplary of the present invention and should not be considered limiting. The present disclosure is intended to serve as a basis of the claims presented herein and as a basis for those skilled in the art to practice this invention.

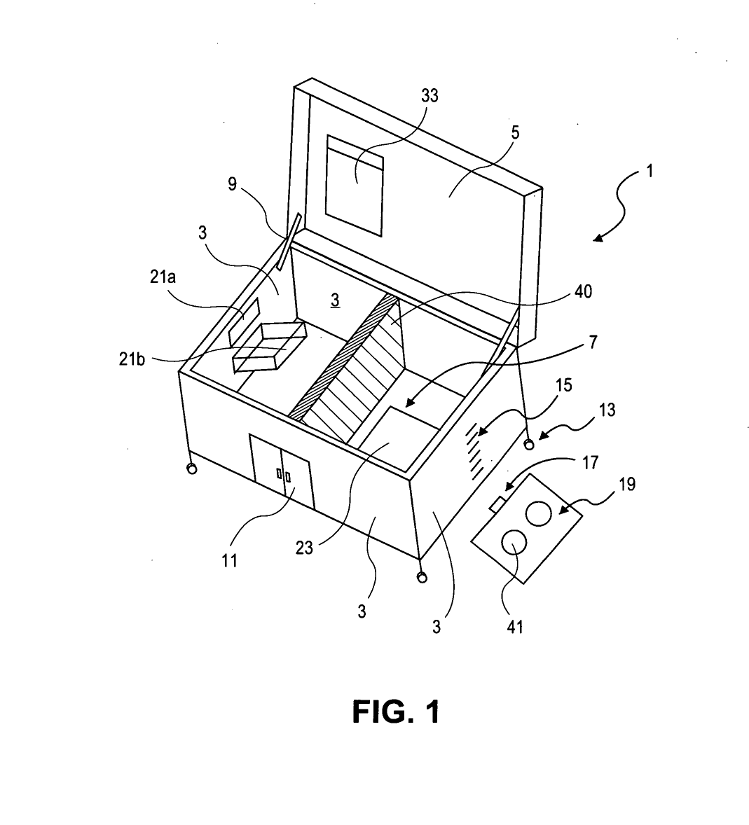

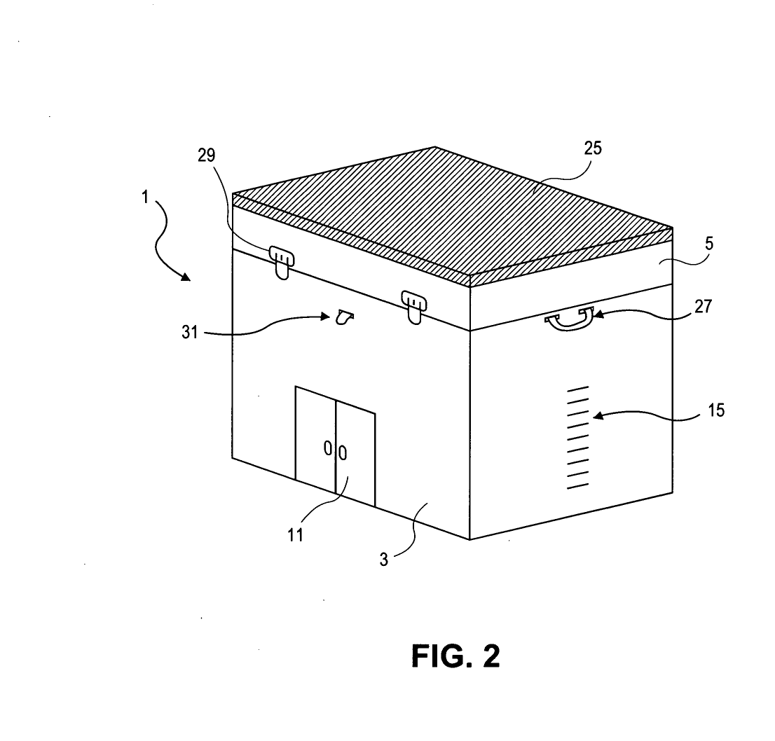

Referring to FIGS. 1-3, a compartment case 1 (or simply “case”) for pet items is disclosed. The case of the present invention comprises a container which has one or more sides along with external platform(s) and other elements described below. The container of the present invention is defined by one or more surfaces and comprises an interior chamber. In the embodiment depicted in FIG. 1 there is a top side 5 and a bottom side 7 shown. Further there are four lateral sides 3 depicted in FIG. 1. In one aspect, the top side 5 is not affixed to the lateral side(s) 3 of the container. In this aspect, the top can be removed by simply lifting it off of the case in which it is disposed. In another aspect, the top is affixed to the case by elements such as hinge brackets 9 which permit the top to be positioned in either an open position, such as is depicted in FIG. 1 or in a closed position (shown in FIG. 2). In yet another aspect, the top may be disposed in a position that is intermediate with respect to being fully closed or fully opened. For example, the top may be disposed at a 45 degree angle (or any other angle from 0 to 90) with respect to one of the sides of the case. In still another aspect, the top 5 can be securely closed by means known to those skilled in the art such as the use of one or more latches 29.

The container of case 1 further comprises an interior chamber which may be defined by the lateral side 3 or sides of the case together with the base side 7. This interior chamber can be used to store pet items such as toys, food, water, cloths, blankets, cushions and the like. The interior chamber can be further defined or partitioned by use of one or more partitioning elements 40. These partitioning elements can be used to subdivide the interior chamber into sub-chambers or spaces. These partitioning elements can extend from one side of the case to the other or can be smaller in size. Their width may vary as well. The key to these partitioning elements is that they can be used to define spaces within the interior of the case thus forming sub-chambers. These partitioning elements can be secured by friction or be disposed within a means, such as a slot, that are affixed to one or more of the sides of the container. One skilled in the art can contemplate other useful and well-known means for securing these partitioning elements.

In one aspect of the present invention, pre-existing sub-chambers 23 can be placed within the interior chamber of the case. These sub-chambers can be permanently affixed or they can be removably affixed within the interior chamber of the case. Examples of such sub-chambers include, without limitation, boxes or containers that fit within the interior chamber of the case.

In one aspect of the present invention one or more sides has an opening which may or may not have a barrier associated therewith. In one embodiment, the opening has a barrier 11. In the particular depiction shown in FIG. 1 it is a door. In one aspect, the door can have a closed position (position 1), such as that shown in FIG. 1, or an open position (position 2). Other suitable barriers are also envisaged to be within the scope of the present invention. A barrier constructed of fabric known to those skilled in the art could also be used. This example is one where the fabric could be affixed above the opening. Other embodiments are also contemplated. For example, the barrier instead of being a door that swings open, it can be a barrier that can be moved from position 1 to position 2 by, for example, sliding the barrier horizontally. In yet another aspect, the barrier can be moved from position 1 to position 2 by sliding the barrier vertically, for example, sliding it vertically towards the top side 5—depending upon the positioning of the opening. The opening may be disposed anywhere along the surface of a given side, for example, it may be disposed more towards the bottom of the case, alternatively, an opening may be disposed towards the top of the case, another alternative is that it may be disposed towards the middle of the case.

In one aspect of the invention, pockets 33 used to store items can be disposed along the interior surface of any side. FIG. 1 depicts a pocket 33 disposed along the interior surface of the top side 5. These pockets can be affixed to the surface by means well known to those skilled in the art. Such mean can include, without limitation, the use of an adhesive between on surface of the pocket and the inner surface of a side. In order to provide an image of a storage pocket one may think of a zip-lock baggy, which are commercially available, affixed to the interior surface of a side 3. Obviously, various permutations of this are considered to be within the scope of the invention.

In one aspect, one or more sides 3 of the container of case 1 can have one or more slots 21a sufficient enough to permit a drawer 21b to be used in conjunction with the present invention. The slot may vary in its dimensions but must accommodate a complimentary drawer.

Other slots 15 are also envisaged to be within the scope of this invention. These slots too are disposed along one or more sides of the case. These slots can be used to receive external platforms. They, slots, essentially act as a female element to compliment a male element disposed associated with or on an external platform. This female—male relationship is but one embodiment that can be used to facilitate the union of the container with an external platform. Other mechanisms for joining an external platform to a side are well known to those skilled in the art and are within the scope of this invention.

In one aspect of the present invention, external platforms include a nutritional platform 19, a planar platform 35a, and a staircase platform 35b. These external platforms in one embodiment have a male element (17 depicted for the nutritional platform, and 37 for both the planar and staircase platforms). The nutritional platform can have one or more receptacles 41 disposed therein. These receptacles can be used to receive, for example, food and/or water bowls. This external platform can be positioned within an appropriate slot depending upon comfort of animal. For example, smaller animals can have their nutritional platform positioned closer to the ground compared to their larger companions.

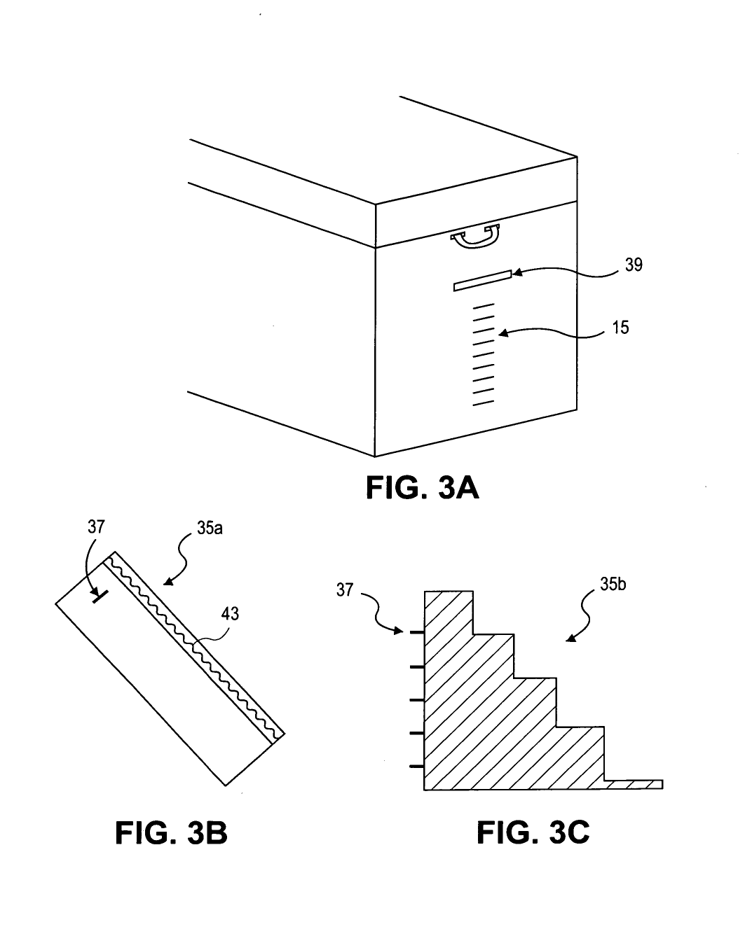

For ease of pet movement from the ground to the top side 5 of the case 1, the present invention contemplates embodiments to facilitate such movement. Referring to FIG. 3, two external platforms are depicted both of which can be removably affixed to one or more sides of the container of case 1. FIG. 3a depicts a planar platform 35a that can be used by an animal to proceed from the ground to the top side 5 of the container. This planar platform can comprise a surface that is rough to increase the friction between the animal and the platform. The platform 35a can be removably affixed to the side of the container using, for example, a male-female system. The platform can comprise a male element 37 that can be used to interact with and securely affixed the platform to a side of the container using one of the slots 15 disposed thereon. Again, this affixation between the platform and side is removable. In one aspect, the planar platform can be bordered 43 using suitable material in order to provide security for the animal. In one aspect, this planar platform may be securely stored in the interior chamber of the container by sliding it into the interior chamber using slot 39 which dimensions are suitable for this maneuver.

Another aspect is envisaged within the scope of this invention that is directed towards facilitating an animal's movement from the ground to the top side 5 of the container of case 1. FIG. 3c depicts a staircase 35b which can be removably affixed to one or more sides of the container using means previously discussed. Again, other means for removable affixation well known to those skilled in the art are also considered to be within the scope of this invention. FIG. 3c depicts a plurality of male elements 37. This represents only one embodiment. Another embodiment envisages only one male element 37 associated with the staircase 35b.

As is true for all of the external platforms, there can be more than one used in any one embodiment. For example, a case 1 can have two sides 3 having one or more slots disposed along its surface. In one example two (or more) nutritional platforms 19 can be used one for each side. Additionally, a combination of external platforms can be used in combination with the container of the present invention, the limitation being the availability of slots disposed along the side(s) of the container. One skilled in the art can design multiple embodiments using this combination of slots (or its equivalence) and external platforms.

Referring to FIG. 2, another aspect of the present invention is envisaged where the top side 5 further comprises a cushion 25. In one embodiment, the cushion is not affixed to the top. In another embodiment, the cushion is affixed to the top. In this embodiment can be permanently or removably affixed to the top by means well known to those skilled in the art. For example, in order to permanently affix the cushion staples, nails or the like can be used to accomplish such a task. For affixing the cushion in a removable fashion Velcro may be used. Additionally, screws or snaps may be employed to removably affix the cushion to the top side.

Additional means for removably affixing the cushion to the top side well known to those skilled in the art are within the scope of this invention.

Returning to FIG. 1, for the ease of mobility, the case 1 can further comprise wheels 13. These wheel can be either permanently disposed on the container of case 1 or can be removable. In one embodiment, the wheels are disposed along the bottom side 7 of the container, as depicted in FIG. 1. However, the wheels may be positioned anywhere along the container as long as they facilitate ease of movement of the case.

Returning to FIG. 2, one or more handles 27 can be disposed on any side of the container. These handles may assist in ease of transport. Further, a device 31 to attach a leash can be disposed along the surface of any side of the container. FIG. 2 depicts such a device 31 as being disposed on one side of the container. Such a device 31 can include, without limitation, a ring securely affixed to the side of the container. The metal ring can be metal, plastic, wood or the like.

Suitable material for any component or element of the case may include wood, stainless steel, plastic, or a combination thereof.

While certain embodiments have been disclosed, it will be understood that there is no intent to limit the invention by such a disclosure. Equivalence embodiments contemplated by those skilled in the art are understood to be within the scope of the present invention as described by the appended claims.

I claim:

1. A compartment case for pet items, comprising a container having one or more interior chambers, wherein said container has a base side, a top side, and at least one lateral side, and wherein said container has one or more portals, and wherein said lateral side has one or more slots.

2. The case of claim 1, wherein said top is hinged to said lateral side.

3. The case of claim 1, wherein said container has four lateral sides.

4. The case of claim 1, wherein said top has one or more latches.

5. The case of claim 4, wherein said latches facilitates an open position and a closure position between said top and a lateral side of said container.

6. The case of claim 1, wherein said container has one or more drawers.

7. The case of claim 1, wherein said portal further comprises a barrier.

8. The case of claim 7, wherein said barrier is a door.

9. The case of claim 8, wherein said door opens outwardly or inwardly with respect to said interior chambers.

10. The case of claim 8, wherein said door slides from position 1 to position 2.

11. The case of claim 1 further comprising one or more external platforms.

12. The case of claim 11, wherein said external platform is selected from the group consisting of a nutritional platform, a staircase platform, a planar platform, and combinations thereof.

13. The case of claim 11, wherein said external platform comprises an element used to removably affix to a side of said container.

14. The case of claim 12, wherein said nutritional platform comprises one or more receptacles.

15. The case of claim 12, wherein said planar platform comprises a rough surface for increased friction between a pet's foot and said surface.

16. The case of claim 1, wherein suitable material includes wood, stainless steel, plastic, and combinations thereof.

17. A compartment case for pet items, comprising a container having one or more interior chambers, wherein said container has a base side, a top side, and at least one lateral side, and wherein said container has one or more portals, and wherein said lateral side has one or more slots, and wherein said case further comprises one or more external platforms.

18. A compartment case for pet items, comprising a container having one or more interior chambers, wherein said container has a base side, a top side, and at least one lateral side, and wherein said container has one or more portals, and wherein said lateral side has one or more slots, and wherein said case further comprises one or more external platforms, and wherein said top side comprises one or more cushions.

19. A compartment case for pet items, comprising a container having one or more interior chambers, wherein said container has a base side, a top side, and at least one lateral side, and wherein said container has one or more portals, and wherein said lateral side has one or more slots, and wherein said case further comprises one or more external platforms, and wherein said top side comprises one or more cushions, and wherein said case further comprises one or more drawers.

20. A compartment case for pet items, comprising a container having one or more interior chambers, wherein said container has a base side, a top side, and at least one lateral side, and wherein said container has one or more portals, and wherein said lateral side has one or more slots, and wherein said case further comprises one or more external platforms, and wherein said external platforms comprise a nutritional platform, and wherein said top side comprises one or more cushions, and wherein said case further comprises one or more drawers.
